(19) United States
(12) Patent Application Publication
(10) Pub. No.: US 2008/0156801 A1
(43) Pub. Date: Jul. 3, 2008

(54) VESSEL HAVING LIQUID METERING APPARATUS

(76) Inventors: CHUN-CHIN TUNG, Chupei (TW); Yung-Lieh Chien, Chupei (TW)

Correspondence Address: G. LINK CO., LTD., 3550 BELL ROAD, MINOOKA, IL, 60447, US

(21) Appl. No.: 11/967,068

(22) Filed: Dec. 29, 2007

(30) Foreign Application Priority Data
Jan. 3, 2007 (TW) 096200085

(51) Int. Cl. B65D 25/00; B65D 43/00; G01F 23/22

(52) U.S. Cl. 220/200; 220/660; 73/304 R

(57) ABSTRACT

A vessel having liquid metering apparatus comprises a liquid vessel and a sensor device. The liquid vessel has a shell body with a hollow storage member. The sensor device contains a sensing member and is disposed in the shell body of the liquid vessel. The sensing member is a planar stripline capacitor and corresponds to the storage member of the liquid vessel such that the sensor device can measure the height of liquid level in the liquid vessel.

### FIELD OF THE INVENTION

The present invention relates to a vessel having liquid metering apparatus, more particularly a metering apparatus assembled in a simple package that can be used to measure fluid level.

### BACKGROUND OF THE INVENTION

Conventional fluid level measuring devices measure the fluid quantity. Fluid measuring devices are generally sizable and complex in structure and hence more costly. However there is increasingly market demand for small-size and low-cost products. Take the example of fuel cell system, its applications in portable electronic devices are picking up. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the liquid fuel level, volume or concentration in the fuel container. Such detection work is typically achieved through expensive metering sensor, which is rather uneconomical when used extensively in portable electrical products.

In addition, the electrochemical reaction in the fuel cell would produce many intermediate products or other products in the process, which might change the fuel temperature as the electrochemical reaction processes and result in measurement error.

In light of the drawbacks of conventional metering devices, the inventor with many years of experience in the industry aims to develop an improved liquid metering device that effectively achieves the objects.

### SUMMARY OF THE INVENTION

The primary object of the invention is to provide a vessel having liquid metering apparatus with a simple and convenient construction for measuring the fluid level or other physical characteristics of liquid in a liquid storage vessel.

Another object of the invention is to provide a vessel having liquid metering apparatus that uses its sensing member to measure capacitance, inductance, impedance or any electric signal in the combination of such signals to obtain corresponding physical characteristics of the liquid stored therein, particularly the level height or volume of the liquid.

Yet another object of the invention is to provide a vessel having liquid metering apparatus that can be used in the fuel storage vessel of a fuel cell system for measuring the fuel level height or fuel volume in the fuel storage vessel.

The vessel having liquid metering apparatus according to the invention comprises a liquid vessel and a sensor device. The liquid vessel has a shell body with a hollow storage member. The sensor device contains a sensing member and is disposed in the shell body of the liquid vessel. The sensing member is a planar stripline capacitor and corresponds to the storage member of the liquid vessel.

In an implementation of the invention in a fuel cell, a first stripline member and a second stripline member have respectively in horizontal direction a plurality of sidewardly extended parallel strip lines that can produce capacitance effect and hence allows the measurement of liquid level of fuel in the vessel.

The objects, features and effects of the invention are described in detail below with embodiments in reference to the accompanying drawings.

### DESCRIPTION OF THE DRAWINGS

FIG. 1 is a sectional view of the vessel having liquid metering apparatus according to a first embodiment of the invention;

FIG. 2 is a diagram of the sensor device in the vessel having liquid metering apparatus according to the invention;

FIG. 3 is an exploded view of the vessel having liquid metering apparatus according to a second embodiment of the invention;

FIG. 4 is a side sectional view of the invention in FIG. 3 in assembly;

FIG. 5 is a partial sectional view of the vessel having liquid metering apparatus according to a third embodiment of the invention;

FIG. 6 is a partial sectional view of the vessel having liquid metering apparatus according to a fourth embodiment of the invention; and

FIG. 7 is a partial sectional view of the vessel having liquid metering apparatus according to a fifth embodiment of the invention.

### DETAILED DESCRIPTION OF THE INVENTION

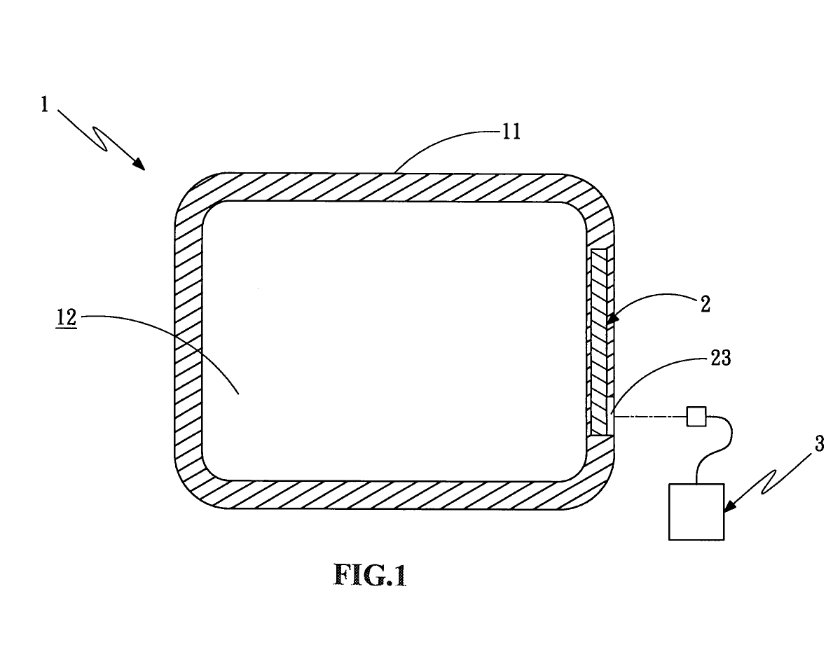

FIG. 1 is sectional view of the vessel having liquid metering apparatus according to a first embodiment of the invention. As shown, the invention provides a vessel having liquid metering apparatus, comprising at least a liquid vessel (1) and a sensor device (2). The liquid vessel (1) is a structure for storing liquid. The sensor device (2) is for measuring the amount of liquid stored in the liquid vessel (1).

In the vessel having liquid metering apparatus, the liquid vessel (1) is made of a shell body (11) having a hollow storage member (12) therein; the sensor device (2) is disposed in a portion of the shell body (11) of the liquid vessel (1) and the sensor device (2) consists of a sensing member (21) and an electric connecting member (23). The sensing member (21) feeds back an electric signal corresponding to the liquid state in the liquid vessel (1), the electric signal being an equivalent capacitance signal, an equivalent inductance signal, an impedance signal or a combination of such signals. The electric connecting member (23) is the input/output port for the transmission of electric signals by the sensor device (2). As such, signals corresponding to the physical characteristics of liquid in the liquid vessel (1) as measured by the sensor device (2) can be output via the electric connecting member (23).

The electric connecting member (23) can further be a connector structure.

The shell body (11) is made by injection molding, and the sensor device (2) is preset in the mold for casting the shell body (11) such that the sensor device (2) is embedded in the shell body (11) in the injection molding process.

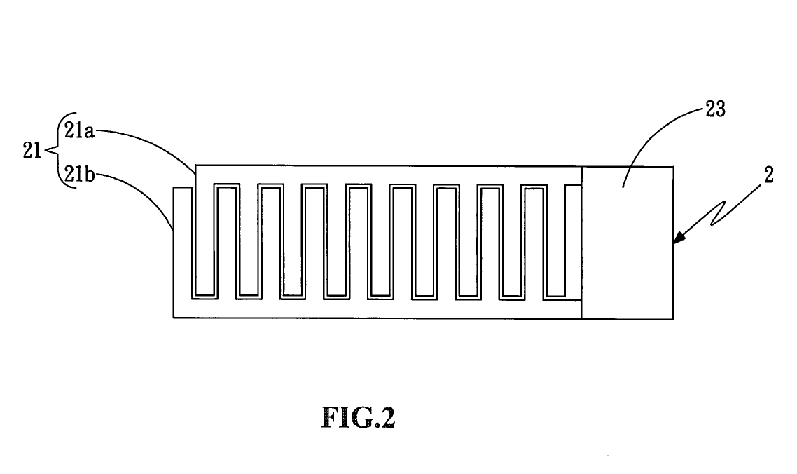

FIG. 2 is a diagram of the sensor device in the vessel having liquid metering apparatus according to the invention. As shown, the sensing member (21) of the sensor device (2) comprises a first stripline member (21a) and a second stripline member (21b). The first stripline member (21a) and the second stripline member (21b) are metal ribbon leads corresponding and parallel to each other to form a stripline structure with capacitance effect that can detect the electric signal corresponding to the state of liquid in the liquid vessel (1). Through such electric signal, the corresponding physical characteristics of the liquid in the liquid vessel (I) may be obtained. In the application in a fuel cell system, the liquid vessel (1) can store fuel needed for the operation of the fuel cell, while the sensing member (21) of the sensor device (2) can be used to measure the level of liquid fuel in the liquid vessel (1), thereby obtaining information on the fuel volume. Moreover, the first stripline member (21a) and the second stripline member (21b) of the sensing member (21) respectively have in horizontal direction a plurality of sidewardly extended strip lines that are alternately arranged and form a planar interdigited capacitor. Under different liquid levels in the liquid vessel (1), the sensor device (21) would correspond to a capacitance value, and based on which, obtains the fuel level, or fuel volume, or other physical characteristics of the fuel in the liquid vessel (I).

The first stripline member (21a) and the second stripline member (21b) are metal ribbon leads parallel to each other to form a stripline structure with capacitance effect.

The vessel having liquid metering apparatus further comprises a metering device (3), the metering device (3) being a device for measuring the physical characteristics of fuel and comprising an electric metering means and a data processing means. The electric metering means detects the electrical property corresponding to the physical state of the liquid in the liquid vessel (1), while the data processing means processes the electrical information detected by the electric metering means and converts the information into the physical characteristics of the liquid fuel.

The metering device (3) is arranged in the liquid vessel (1) and electrically connected to the sensor device (2) such that the metering device (3) capture the electrical signal from sensor device (2) and converts the signal into the liquid level or volume in the liquid vessel (1). Moreover, the metering device (3) is electrically connected to the sensor device (2) via the electric connecting member (23) of the sensor device (2).

The vessel having liquid metering apparatus just described can be used in the fuel storage vessel of a fuel cell system (not shown in the figure) for measuring the fuel level height or fuel volume in the fuel storage vessel.

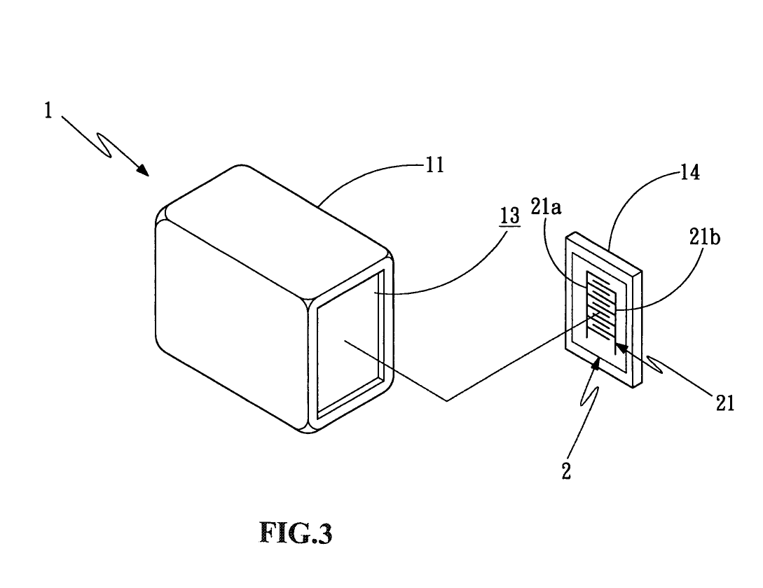

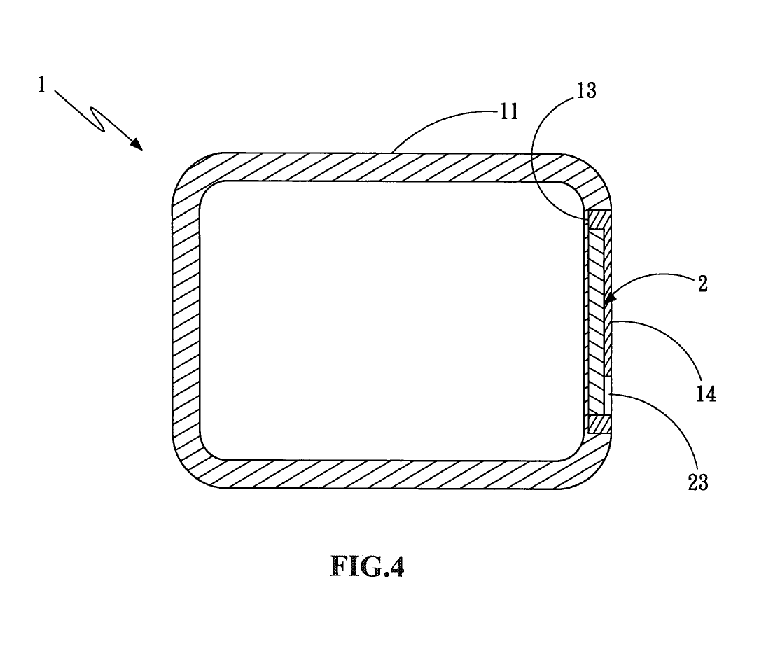

FIG. 3 is an exploded view of the vessel having liquid metering apparatus according to a second embodiment of the invention; FIG. 4 is a side sectional view of the invention in FIG. 3 in assembly. As shown, the shell body (11) of the liquid vessel (1) contains a concavity (13) and a lid (14). The concavity (13) is an inwardly concave structure on a part of the outer surface of shell body (11). The lid (14) corresponds to the concavity (13) such that the lid (14) can seal the concavity (13). Moreover, the sensing member (21) of the sensor device (2) is disposed between the opposing surfaces of the concavity (13) and the lid (14), while the electric connecting member (23) is securely installed on and through the lid (14).

In a second embodiment of the vessel having liquid metering apparatus according to the invention, more specifically the first stripline member (21a) and the second stripline member (21b) of the sensing member (21) are laid over the surface of the lid (14) facing the concavity (13), while the electric connecting member (23) is securely installed on the lid (14) and electrically connected to the sensing member (21).

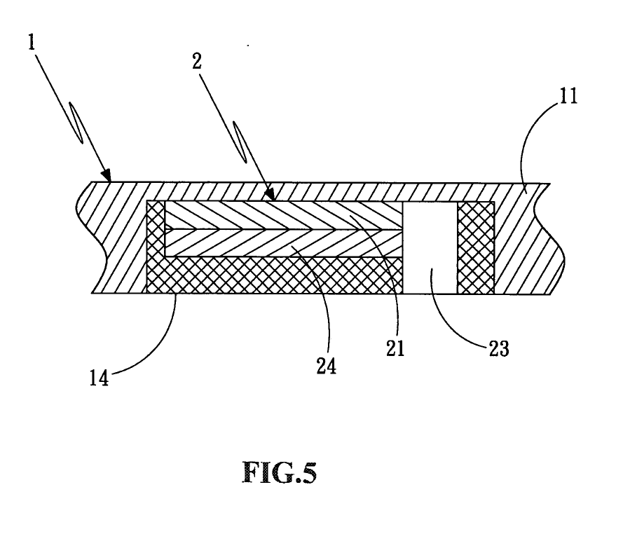

FIG. 5 is a partial sectional view of the vessel having liquid metering apparatus according to a third embodiment of the invention. As shown, the sensor device (2) further comprises a circuit board (24) with the sensing member (21) disposed on one side surface of the circuit board (24) and facing the concavity (13) on the shell body (11) of the liquid vessel (1), while the other side surface of the circuit board (24) is adhered to the lid (14) of the liquid vessel (1).

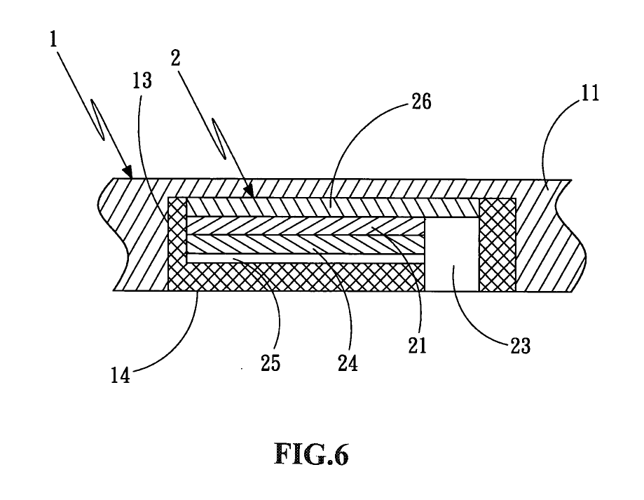

FIG. 6 is a partial sectional view of the vessel having liquid metering apparatus according to a fourth embodiment of the invention. As shown, there is provided a shield layer (25) on the surface of the circuit board (24) of the sensor device (2) opposing the lid (14), the shield layer (25) being made of conductive metal material and able to block the propagation of electromagnetic signals from the direction of the lid (14) to the circuit board (24) to cut down the interference in the sensing member (21) of the sensor device (2).

The outer surfaces of the sensing member (21) can be coated with a protective layer (26). The material for the protective layer (26) may be selected from a group of non-polarized material consisting of FR4, FR5, epoxy resin, glass fiber laminate, ceramic laminate, polymer laminate, Teflon, and their mixtures thereof to protect the sensing member (21) and protect the sensing member (21) from corrosive fluid leaked out of the liquid vessel (1). In addition, the protective layer (26) can envelope the entire sensor device (2).

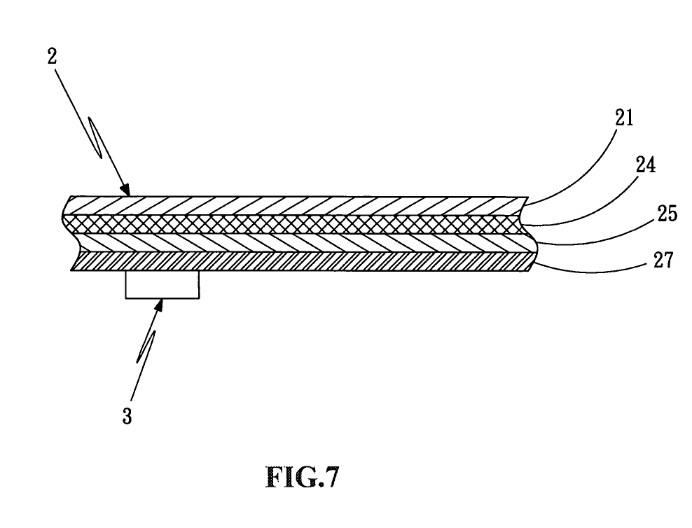

FIG. 7 is a partial sectional view of the vessel having liquid metering apparatus according to a fifth embodiment of the invention. As shown, the sensor device (2) comprises the sensing member (21), the circuit board (23), the shield layer (25), and a bottom circuit board (27) stacked up in such order to form a multi-layered structure. The metering device (3) can be disposed on the other surface of the bottom circuit board (27).

As such, the vessel having liquid metering apparatus provided by the invention can accurately measure the physical characteristics of fuel in a fuel cell with a simple assembly. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A vessel having liquid metering apparatus, comprising:
a liquid vessel having a shell body with a hollow storage member; and
a sensor device consisting of a sensing member disposed in the shell body of the liquid vessel and being a planar stripline capacitor;
wherein the sensing member corresponds to the storage member of the liquid vessel.

2. The vessel having liquid metering apparatus to claim 1, further comprising an electric connecting member, the electric connecting member being electrically connected to the sensing member and disposed in the shell body of the liquid vessel.

3. The vessel having liquid metering apparatus to claim 2, wherein the electric connecting member is a connector.

4. The vessel having liquid metering apparatus to claim 1, wherein the sensor device measures any of the following signals: equivalent capacitance, equivalent inductance, impedance, and a combination of such signals.

5. The vessel having liquid metering apparatus to claim 1, wherein the sensing member consists of a first stripline member and a second stripline member, the first stripline member and the second stripline member having respectively in horizontal direction a plurality of sidewardly extended strip lines.

6. The vessel having liquid metering apparatus to claim 5, wherein the sidewardly extended parallel strip lines of the first stripline member and the second stripline member in horizontal direction are alternately arranged.

7. The vessel having liquid metering apparatus to claim 5, wherein the sensing member is a planar interdigited capacitor.

8. The vessel having liquid metering apparatus to claim 1, wherein the shell body of the liquid vessel contains a concavity and a lid, the concavity being an inwardly concave structure on a part of the outer surface of shell body, the lid being opposing the concavity, the sensing member of the sensor device being disposed between the opposing surfaces of the concavity and the lid, while a metering device being disposed on the surface opposing the sensor device.

9. The vessel having liquid metering apparatus to claim 8, further comprising an electric connecting member, the electric connecting member being electrically connected to the sensing member and disposed on and through the lid.

10. The vessel having liquid metering apparatus to claim 9, wherein the electric connecting member is a connector.

11. The vessel having liquid metering apparatus to claim 8, wherein the sensing member is laid over the surface of the lid facing the concavity.

12. The vessel having liquid metering apparatus to claim 8, wherein the metering device is disposed in the shell body of the liquid vessel.

13. The vessel having liquid metering apparatus to claim 8, wherein the metering device is electrically connected to the electric connecting member of the sensor device.

14. The vessel having liquid metering apparatus to claim 1, further comprising a circuit board, the sensing member being disposed on one side surface of the circuit board and facing the concavity of the shell body of the liquid vessel, while the other side surface of the circuit board being adhered to the lid of the liquid vessel.

15. The vessel having liquid metering apparatus to claim 14, wherein the surface of the circuit board of the sensor device opposing the lid is coated with a shield layer, the shield layer being made of conductive metal material.

16. The vessel having liquid metering apparatus to claim 15, wherein the sensor device further contains a bottom circuit board, the bottom circuit board being disposed a surface between the shield layer and the lid.

17. The vessel having liquid metering apparatus to claim 16, further comprising a metering device, the metering device being electrically connected to the sensor device and comprising an electric metering means and a data processing means, the metering device being disposed on a surface between the bottom circuit board and the lid.

18. The vessel having liquid metering apparatus to claim 1, wherein the outer surfaces of the sensing member is coated with a protective layer.

19. The vessel having liquid metering apparatus to claim 18, wherein the material of protective layer is selected from a group of non-polarized material consisting of FR4, FR5, epoxy resin, glass fiber laminate, ceramic laminate, polymer laminate, Teflon, and their mixtures thereof.

20. The vessel having liquid metering apparatus to claim 1, further comprising a metering device, the metering device being electrically connected to the sensor device and comprising an electric metering means and a data processing means.

21. The vessel having liquid metering apparatus to claim 1, wherein the liquid vessel is a fuel storage device of a fuel cell.

22. The vessel having liquid metering apparatus to claim 1, wherein the shell body is made by injection molding and the sensor device is preset in the mold for casting the shell body such that the sensor device is embedded in the shell body in the injection molding process.
